(19) United States
(12) Patent Application Publication
(10) Pub. No.: US 2026/0088746 A1
(43) Pub. Date: Mar. 26, 2026

(54) Motor Control Apparatus and Motor Control Method

(71) Applicant: Hitachi Astemo, Ltd., Hitachinaka-shi, Ibaraki (JP)

(72) Inventors: Hiroto SAOTOME, Hitachinaka-shi, Ibaraki (JP); Masaki HANO, Hitachinaka-shi, Ibaraki (JP); Makoto JITSUISHI, Hitachinaka-shi, Ibaraki (JP)

(21) Appl. No.: 19/111,906

(22) PCT Filed: Dec. 4, 2023
(86) PCT No.: PCT/JP2023/043233

§ 371 Date: Mar. 14, 2025

(30) Foreign Application Priority Data
Dec. 21, 2022 (JP) 2022-204071

(51) Int. Cl. H02P 23/28; H02P 23/14; H02P 27/08

(52) U.S. Cl. CPC H02P 23/28; H02P 23/14; H02P 27/085; H02P 2205/01

(57) ABSTRACT

In one mode, a motor control apparatus and a motor control method according to the present invention acquire a detected signal of a current sensor that detects a current flowing through the energized phases of a three-phase brushless motor, and execute 120-degree square-wave drive on the three-phase brushless motor based on a control current value based on the detected signal. The motor control apparatus and motor control method calculate the control current value based on a current value detected by the current sensor before switching of the energized phases in the 120-degree square-wave drive and based on a current value detected by the current sensor after the switching. This configuration enables reduction of oscillation of a motor current.

### TECHNICAL FIELD

The present invention relates to motor control apparatuses and to motor control methods.

### BACKGROUND ART

A control device for a compressor of Patent Document 1 includes position detection means for detecting the rotational position of the rotor of a brushless motor, inverter control means for driving an inverter by energizing and sequentially switching two specific phases of the three-phase stator windings of the brushless motor in response to a signal from the position detection means, and current control means for controlling a current in an individual two-phase energization section of the inverter such that the current has a waveform similar to a waveform of a no-load induced voltage of the brushless motor.

### REFERENCE DOCUMENT LIST

### Patent Document

Patent Document 1: JP 2001-263256 A

### SUMMARY OF THE INVENTION

### Problem to be Solved by the Invention

When 120-degree square-wave drive is executed on a three-phase brushless motor, the motor current temporarily drops when the energized phases are switched.

Therefore, if a detected value of a current sensor that detects the currents flowing through the energized phases of the three-phase brushless motor is used as it is for energization control, the motor current oscillates, and this oscillation of the motor current may cause an overcurrent, a torque control failure, etc.

The present invention has been made in view of the conventional circumstances, and an object of the present invention is to provide a motor control apparatus and a motor control method that achieve reduction of oscillation of a motor current in 120-degree square-wave drive of a three-phase brushless motor.

### Means for Solving the Problem

In one mode, a motor control apparatus according to the present invention includes a control unit. The control unit is configured to acquire a detected signal of a current sensor that detects a current flowing through the energized phases of a three-phase brushless motor, and to execute 120-degree square-wave drive on the three-phase brushless motor, based on a control current value based on the detected signal. In addition, the control unit calculates the control current value based on a current value detected by the current sensor before switching of the energized phases and a current value detected by the current sensor after the switching.

Furthermore, in one mode, a motor control method according to the present invention is executed by the control unit that executes 120-degree square-wave drive on a three-phase brushless motor. The motor control method includes: acquiring a detected signal of a current sensor that detects a current flowing through the energized phases of the three-phase brushless motor; calculating a control current value based on the detected signal; and outputting a control signal to a drive circuit of the three-phase brushless motor based on the control current value. In the calculating of the control current value, the control current value is calculated based on a current value detected by the current sensor before switching of the energized phases and a current value detected by the current sensor after the switching.

### Effects of the Invention

The above invention achieves reduction of oscillation of a motor current in the 120-degree square-wave drive of a three-phase brushless motor.

### BRIEF DESCRIPTION OF THE DRAWINGS

FIG. 1 is a diagram illustrating a system of an internal combustion engine for a vehicle.

FIG. 2 is a block diagram illustrating a control system of a three-phase brushless motor.

FIG. 3 is a time chart illustrating PWM control patterns of an inverter.

FIG. 4 is a time chart illustrating, as examples, phase voltages and a phase-to-phase voltage when complementary PWM is not executed.

FIG. 5 is a time chart illustrating, as examples, phase voltages and a phase-to-phase voltage when complementary PWM is executed.

FIG. 6 is a time chart illustrating phase voltages and a shunt current when pulse shift control is not executed.

FIG. 7 is a time chart illustrating phase voltages and a shunt current when pulse shift control is executed.

FIG. 8 is a time chart illustrating a phase current that drops when the energized phases are switched.

FIG. 9 is a time chart illustrating details of a response delay process.

FIG. 10 is a time chart illustrating the response delay process executed in a low-speed rotational range of a motor.

FIG. 11 is a time chart illustrating the response delay process executed in a high-speed rotational range of the motor.

FIG. 12 is a time chart illustrating effects of the response delay process.

FIG. 13 is a diagram indicating that a phase current drops in a drive mode.

FIG. 14 is a diagram indicating that a phase current does not drop in a regeneration mode.

### MODE FOR CARRYING OUT THE INVENTION

Hereinafter, an example of the present invention will be described.

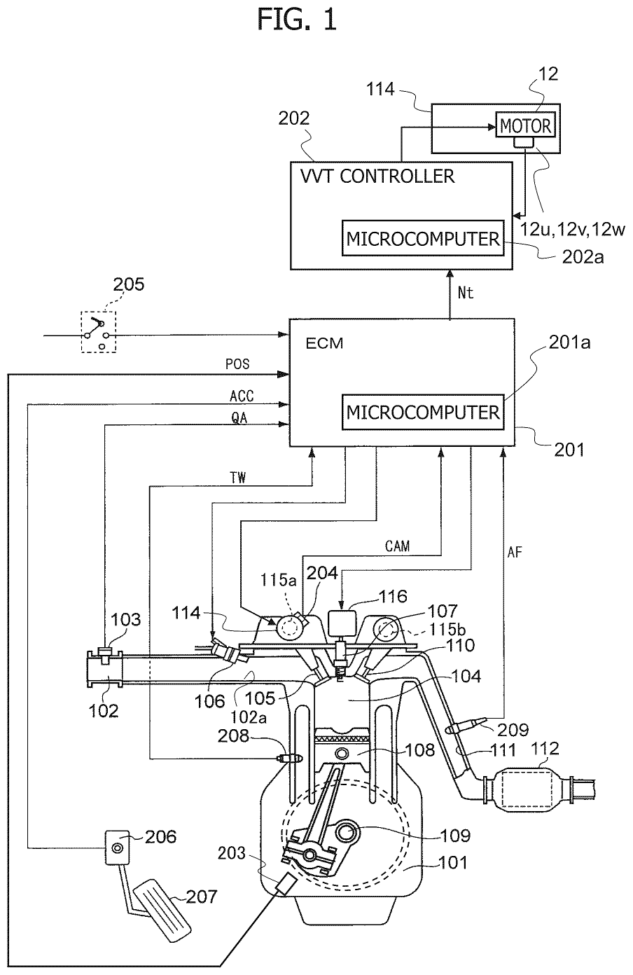

FIG. 1 is a diagram illustrating an internal combustion engine for a vehicle. This internal combustion engine is provided with a three-phase brushless motor to which a motor control apparatus and a motor control method according to the present invention are applied.

An internal combustion engine 101 includes an intake duct 102, which is provided with an intake air quantity sensor 103 that detects an intake air flow quantity QA of internal combustion engine 101.

An individual intake valve 105 opens and closes the intake port of a combustion chamber 104 of its corresponding cylinder.

An individual fuel injection valve 106 injects fuel into an intake port 102a of its corresponding cylinder.

The fuel injected by individual fuel injection valve 106 is drawn into corresponding combustion chamber 104 together with air via corresponding intake valve 105. The mixture is ignited by a spark generated by an individual spark plug 107 and combusts.

The combustion pressure pushes an individual piston 108 down toward a crankshaft 109, which consequently rotates.

An individual exhaust valve 110 opens and closes the exhaust port of corresponding combustion chamber 104. When exhaust valve 110 is opened, exhaust gas in corresponding combustion chamber 104 is discharged to an exhaust pipe 111.

Exhaust pipe 111 is provided with a catalytic converter 112 containing a catalyst such as a three-way catalyst.

Individual intake valve 105 opens and closes with the rotation of an intake camshaft 115a rotated by crankshaft 109.

Individual exhaust valve 110 opens and closes with the rotation of an exhaust camshaft 115b rotated by crankshaft 109.

An electric variable valve timing mechanism 114 (hereinafter, referred to as “VVT mechanism 114”) is a mechanism for continuously advancing or delaying the valve timing of individual intake valve 105, which is an engine valve, by changing the rotational phase of intake camshaft 115a with respect to crankshaft 109 based on the rotational speed of a three-phase brushless motor 12 functioning as an actuator.

VVT mechanism 114 has a known structure disclosed in Japanese Patent No. 7085629 A, for example.

Hereinafter, an overview of one mode of the structure and operation of VVT mechanism 114 will be described.

VVT mechanism 114 is disposed between a timing sprocket (not illustrated) and intake camshaft 115a, and has a phase shift mechanism for shifting the relative rotational phase between the timing sprocket and intake camshaft 115a.

The phase shift mechanism includes three-phase brushless motor 12 and a speed reduction mechanism for reducing the rotational speed of three-phase brushless motor 12 and transmitting the reduced rotational speed to intake camshaft 115a.

When three-phase brushless motor 12 is rotated in the forward direction or the reverse direction, the rotational force is transmitted to intake camshaft 115a, whereby intake camshaft 115a rotates relative to the timing sprocket, and the relative rotational phase between intake camshaft 115a and the timing sprocket is changed.

An individual ignition module 116 is directly attached to corresponding spark plug 107 and supplies ignition energy to corresponding spark plug 107.

Individual ignition module 116 includes an ignition coil and a power transistor that controls the current supplied to the ignition coil.

A control system that controls the operation of internal combustion engine 101 includes an engine control module 201 (hereinafter, referred to as “ECM 201”) that controls the fuel injection by individual fuel injection valve 106 and ignition by individual spark plug 107, and includes a VVT controller 202 that controls the valve timing of VVT mechanism 114.

VVT controller 202 corresponds to a motor control apparatus that controls three-phase brushless motor 12, which is an actuator of VVT mechanism 114.

ECM 201 is an electronic control apparatus including a microcomputer 201a, and VVT controller 202 is an electronic control apparatus including a microcomputer 202a.

Microcomputers 201a and 202a each include a processor, a nonvolatile memory, a volatile memory, etc.

ECM 201 acquires signals that are output from various kinds of sensors, and calculates and outputs the operation amounts of individual fuel injection valve 106, individual ignition module 116, etc., by executing calculation processing in accordance with programs stored in advance in the nonvolatile memory.

VVT controller 202 acquires signals that are transmitted from ECM 201 and signals that are output from various kinds of sensors, and calculates and outputs the operation amount of three-phase brushless motor 12 of VVT mechanism 114 by executing calculation processing in accordance with a program stored in advance in the nonvolatile memory.

Internal combustion engine 101 includes, as the above-described various kinds of sensors, not only intake air quantity sensor 103, but also a crank angle sensor 203 that outputs a crank angle signal POS each time crankshaft 109 reaches a predetermined angular position, an accelerator position sensor 206 that detects the pressing amount of an accelerator pedal 207, in other words, an accelerator position ACC, a cam angle sensor 204 that outputs a cam angle signal CAM each time intake camshaft 115a reaches a predetermined angular position, a water temperature sensor 208 that detects a temperature TW of cooling water of internal combustion engine 101, and an air-fuel ratio sensor 209 that is disposed in exhaust pipe 111 upstream of catalytic converter 112 and that detects an air-fuel ratio AF based on the oxygen concentration in the exhaust gas.

Crank angle signal POS that is output from crank angle sensor 203 is a pulse signal that rises and falls based on each unit crank angle, and its signal output pattern is set such that one or a plurality of continuous pulses are missing at each crank angle corresponding to the stroke phase difference between cylinders.

Herein, ECM 201 detects the pulse signal missing position in crank angle signal POS as a reference crank angle position.

Cam angle signal CAM is output from cam angle sensor 204 at each crank angle corresponding to the stroke phase difference between cylinders.

ECM 201 acquires signals that are output from these various kinds of sensors, and also acquires an ON/OFF signal for an ignition switch 205, which is a main switch for starting and stopping internal combustion engine 101.

Three-phase brushless motor 12 of VVT mechanism 114 includes Hall sensors 12u, 12v, and 12w as motor rotational position sensors for detecting the positional relationship between the rotor and three phase coils of a U-phase coil, a V-phase coil, and a W-phase coil. VVT controller 202 acquires signals that are output from Hall sensors 12u, 12v, and 12w.

ECM 201 calculates a target rotational phase, which is a target value of the rotational phase of intake camshaft 115a with respect to crankshaft 109, based on engine operation states such as engine load and engine rotational speed obtained from the signals that are output from the above-described various kinds of sensors. ECM 201 also calculates an actual rotational phase based on crank angle signal POS and cam angle signal CAM.

Next, ECM 201 calculates a target rotational speed Nt of three-phase brushless motor 12 of VVT mechanism 114 such that the actual rotational phase approaches the target rotational phase, and transmits a signal of target rotational speed Nt to VVT controller 202.

After acquiring the signal of target rotational speed Nt, VVT controller 202 obtains a command current value CCV, which is a target value of the motor current, such that the actual rotational speed of three-phase brushless motor 12 approaches target rotational speed Nt, and controls the operation amount of three-phase brushless motor 12 such that the actual motor current approaches command current value CCV.

That is, VVT controller 202 controls the current supplied to three-phase brushless motor 12 of VVT mechanism 114 based on speed feedback control.

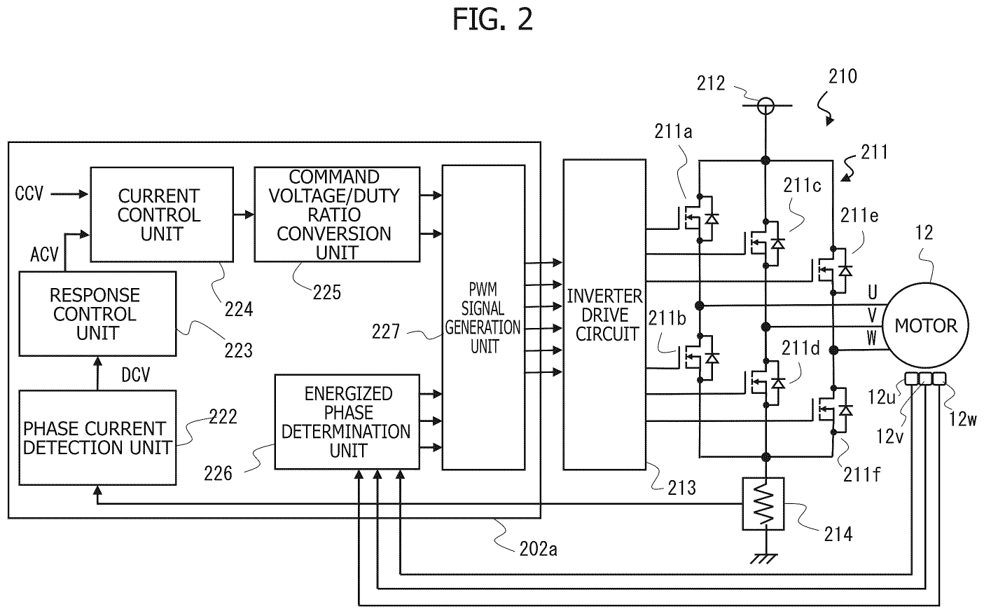

FIG. 2 is a block diagram illustrating a drive circuit 210 for three-phase brushless motor 12, drive circuit 210 being included in VVT controller 202. FIG. 2 also illustrates functions of microcomputer 202a of VVT controller 202, the functions controlling three-phase brushless motor 12.

Microcomputer 202a of VVT controller 202 drives three-phase brushless motor 12 by executing 120-degree square-wave drive in which, among the three phases of the three-phase brushless motor 12, two phases to which a voltage is applied are sequentially switched.

That is, microcomputer 202a is a control unit that executes a motor control method such that three-phase brushless motor 12 is driven based on 120-degree square waves.

In the 120-degree square-wave drive, six patterns are switched every 60-degree rotation. For example, a current flows from the U phase to the V phase in a first pattern, a current flows from the U phase to the W phase in a second pattern, a current flows from the V phase to the W phase in a third pattern, a current flows from the V phase to the U phase in a fourth pattern, a current flows from the W phase to the U phase in a fifth pattern, and a current flows from the W phase to the V phase in a sixth pattern.

By switching these energization patterns, for example, the phase U is energized for 120 degrees in the first pattern and the second pattern, is not energized for 60 degrees in the third pattern, and is energized again for 120 degrees in the fourth pattern and the fifth pattern. The 120-degree square-wave drive is also referred to as “120-degree energization” or “square-wave drive”.

Three-phase brushless motor 12 includes a cylindrical stator provided with three-phase coils, which are the U-phase, V-phase, and W-phase coils and are star-connected. Three-phase brushless motor 12 also includes a rotatable rotor, which is formed of a permanent magnet, in a space formed in a central portion of the stator.

Hall sensors 12u, 12v, and 12w are disposed at intervals of 120 degrees around the rotor. By combining the sensor signals of Hall sensors 12u, 12v, and 12w, the individual timing at which the energization pattern is switched every 60 degrees is detected.

Drive circuit 210 for three-phase brushless motor 12 includes an inverter 211, a direct-current (DC) power supply 212 for inverter 211, and an inverter drive circuit 213.

Inverter 211 is configured by connecting semiconductor switching elements 211a to 211f such as FETs in a three-phase bridge configuration, and supplies alternate-current (AC) power to three-phase brushless motor 12.

The gate terminals of semiconductor switching elements 211a to 211f of inverter 211 are connected to output ports of inverter drive circuit 213.

Inverter drive circuit 213 outputs gate control signals to gate terminals of semiconductor switching elements 211a to 211f, and turning ON and OFF of semiconductor switching elements 211a to 211f are switched based on the gate control signals.

A shunt resistor 214 (in other words, a current sensor) for detecting the motor current is disposed on a DC bus line between inverter 211 and a ground GND.

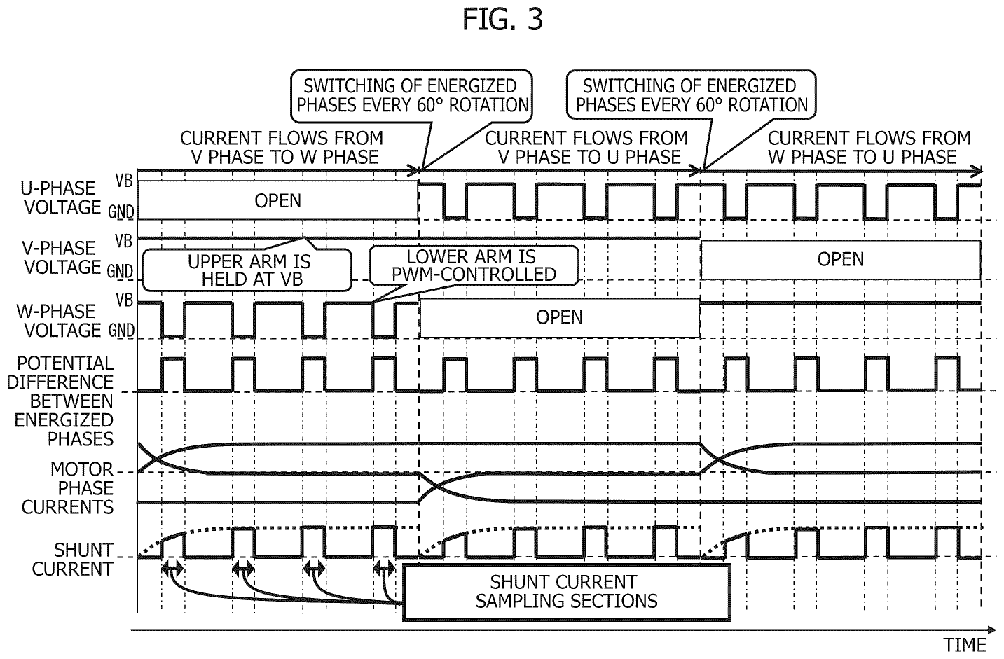

FIG. 3 illustrates one mode of PWM control patterns of switching elements 211a to 211f in the 120-degree square-wave drive.

This operation example in FIG. 3 adopts lower-arm chopper control in which turning ON and OFF of lower-arm semiconductor switching elements 211b, 211d, and 211f is PWM-controlled while upper-arm semiconductor switching elements 211a, 211c, and 211e are held ON.

For example, when a current is supplied from the V phase to the W phase, turning ON and OFF of the W-phase lower-arm semiconductor switching element 211f is PWM-controlled while the V-phase upper-arm semiconductor switching element 211c is held ON.

In this case, by setting semiconductor switching element 211c to ON, the V-phase terminal voltage is set to the power supply potential. In addition, by setting semiconductor switching element 211f to ON, the W-phase terminal voltage is set to the ground potential. Thus, a potential difference is generated between the energized phases, and a current flows from the V phase to the W phase.

That is, an energized-phase current flows through shunt resistor 214 during the ON period of the PWM-controlled lower-arm semiconductor switching element.

Thus, microcomputer 202a samples the current flowing through shunt resistor 214 and detects the energized-phase current value during the ON period of the lower-arm semiconductor switching element. The ON period is a timing at which the energized-phase current flows through shunt resistor 214.

Alternatively, upper-arm chopper control may be adopted. In this case, turning ON and OFF of the upper-arm semiconductor switching elements is PWM-controlled while the lower-arm semiconductor switching elements are held ON.

In addition, microcomputer 202a can execute complementary PWM (in other words, complementary upper-lower switching) in the 120-degree square-wave drive.

The complementary PWM refers to switching control by which a lower-arm semiconductor switching element and an upper-arm semiconductor switching element are turned ON and OFF in opposite phases to each other.

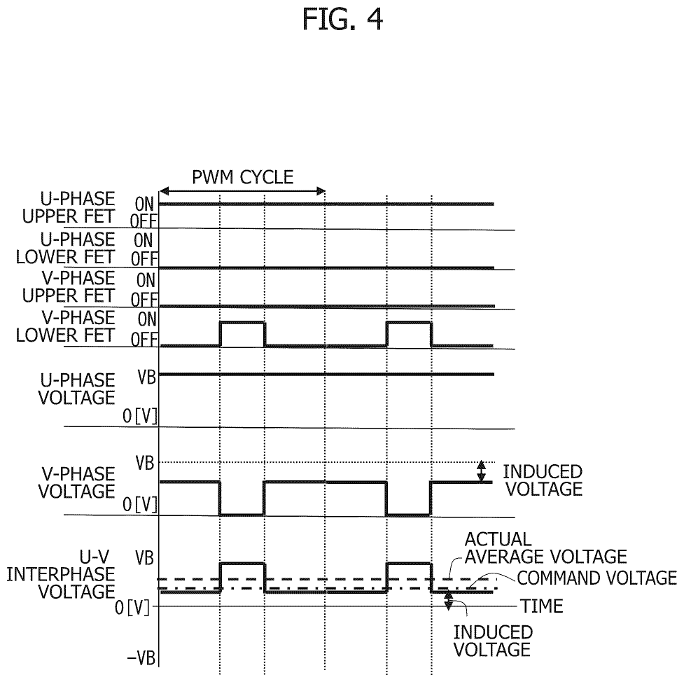

FIG. 4 illustrates an example of a switching operation for flowing a current from the U phase to the V phase when complementary PWM is not executed.

In FIG. 4, the U-phase upper-arm semiconductor switching element 211a is held ON, and the U-phase lower-arm semiconductor switching element 211b is held OFF.

Turning ON and OFF of the V-phase lower-arm semiconductor switching element 211d is PWM-controlled with a duty ratio of “command voltage/power supply voltage VB”, and the V-phase upper-arm semiconductor switching element 211c is held OFF.

In the case in which the complementary PWM is not executed as illustrated in FIG. 4, because the phase-to-phase voltage during the individual non-energized period corresponds to an induced voltage, the average voltage deviates from the command voltage. Thus, controllability of the current and the number of rotations of three-phase brushless motor 12 is reduced.

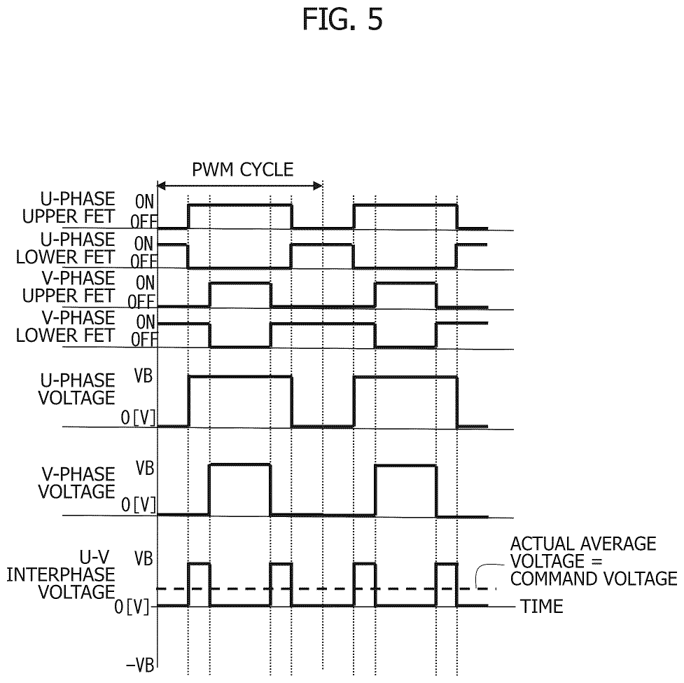

In contrast, FIG. 5 illustrates an example of a switching operation for flowing a current from the U phase to the V phase when complementary PWM is executed.

In FIG. 5, turning ON and OFF of the U-phase upper-arm semiconductor switching element 211a is PWM-controlled with a duty ratio of “50%+command voltage/power supply voltage VB/2”, and the U-phase lower-arm semiconductor switching element 211b is turned ON and OFF in the phase opposite to that of the upper-arm semiconductor switching element 211a.

The turning ON and OFF of the V-phase upper-arm semiconductor switching element 211c is PWM-controlled with a duty ratio of “50%-command voltage/power supply voltage VB/2”, and the V-phase lower-arm semiconductor switching element 211d is turned ON and OFF in the phase opposite to that of the V-phase upper-arm semiconductor switching element 211c.

When the complementary PWM illustrated in FIG. 5 is executed, there is no non-energized period, except for dead time. Thus, the phase-to-phase voltage is fixed at 0 V or power supply voltage VB, and the average voltage becomes equal to the command voltage.

Therefore, controllability of the current and the rotation speed of three-phase brushless motor 12 is improved.

In addition, microcomputer 202a can execute pulse shift control. In this way, when the duty ratio in the PWM control is small, by shifting the phase of the PWM pulse, the current detection period for shunt resistor 214 can be secured.

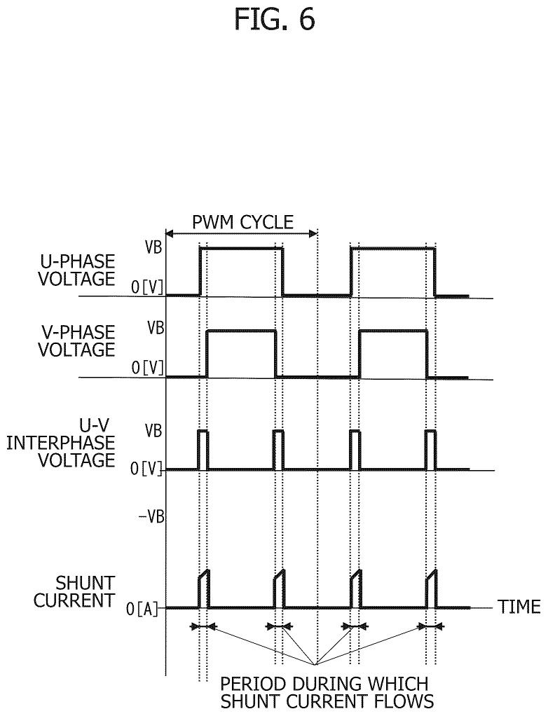

FIG. 6 illustrates phase voltages and a shunt current in a switching operation for flowing a current from the U phase to the V phase when the pulse shift control is not executed.

In this case, when the duty ratio is small, the individual time period during which the shunt current flows becomes shorter than a predetermined minimum time (lower limit time) for current detection, and consequently, it becomes impossible to detect the current.

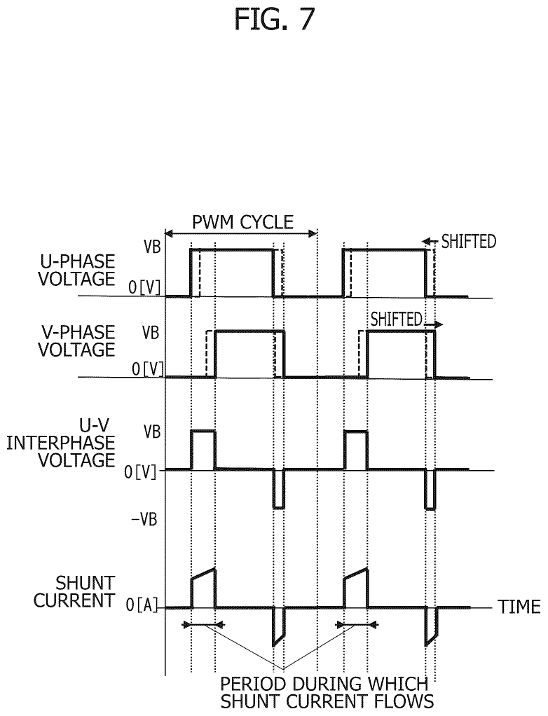

In contrast, FIG. 7 illustrates phase voltages and a shunt current in a switching operation for flowing a current from the U phase to the V phase when the pulse shift control is executed.

By executing the pulse shift control, microcomputer 202a advances the phase of the PWM pulse for controlling the U-phase voltage and delays the phase of the PWM pulse for controlling the V-phase voltage. The pulse shift control extends the individual time period in which the U-phase to V-phase voltage reaches+power supply voltage VB, compared with the corresponding time period when the pulse shift control is not executed. In addition, the pulse shift control generates periods in which the U-phase to V-phase voltage reaches-power supply voltage VB. The duration of each generated period matches the duration of the individual extension in which the U-V phase-to-phase voltage reaches+power supply voltage VB. This pulse shift control is executed such that the average voltage does not change.

In this way, even if the duty ratio is low, the pulse shift control is able to maintain the shunt current flow time to be equal to or longer than the minimum time for current detection, and therefore, the current detection is enabled.

Next, functions of microcomputer 202a, the functions being illustrated in FIG. 2 and controlling three-phase brushless motor 12, will be described in detail.

Microcomputer 202a includes functional units such as a phase current detection unit 222, a response control unit 223, a current control unit 224, a command voltage/duty ratio conversion unit 225, an energized phase determination unit 226, and a PWM signal generation unit 227.

Phase current detection unit 222 converts the potential difference across shunt resistor 214 into a current value, so as to obtain a detected current value DCV (in other words, an unprocessed current value), which is the current value of the current flowing through the energized phases of three-phase brushless motor 12.

That is, shunt resistor 214 and phase current detection unit 222 constitute a current sensor that detects the current flowing through the energized phases of three-phase brushless motor 12.

As described above, phase current detection unit 222 samples the current value based on the potential difference across shunt resistor 214 as detected current value DCV within the individual ON control period of the PWM-controlled semiconductor switching element among semiconductor switching elements 211a to 211f constituting inverter 211.

Response control unit 223 is a functional unit that processes detected current value DCV detected by phase current detection unit 222 to obtain a control current value ACV (in other words, a current value recognized by microcomputer 202a), which is an actual phase current value used for controlling inverter 211. Response control unit 223 executes a process for delaying the response of control current value ACV to detected current value DCV when the energized phases are switched.

The function of response control unit 223 will be described in detail below.

Current control unit 224 acquires control current value ACV (in other words, the actual phase current), which is output by response control unit 223, and acquires command current value CCV (in other words, the target phase current) based on a control error of the rotational phase, so as to obtain a command voltage value CVV.

Command voltage/duty ratio conversion unit 225 converts command voltage value CVV acquired from current control unit 224 into a duty ratio used in the PWM control of semiconductor switching elements 211a to 211f constituting inverter 211.

Energized phase determination unit 226 creates energized phase switching information (in other words, energized phase designation information) for every 60-degree rotation by combining the sensor signals of Hall sensors 12u, 12v, and 12w.

PWM signal generation unit 227 acquires duty ratio signals from command voltage/duty ratio conversion unit 225, and acquires the energized phase switching information from energized phase determination unit 226.

PWM signal generation unit 227 generates PWM signals for semiconductor switching elements 211a to 211f constituting inverter 211, based on the acquired duty ratio signals and energized phase switching information.

Inverter drive circuit 213 acquires the PWM signals generated by PWM signal generation unit 227, and outputs gate signals for semiconductor switching elements 211a to 211f constituting inverter 211 based on the acquired PWM signals.

Hereinafter, the function of response control unit 223 will be described in detail.

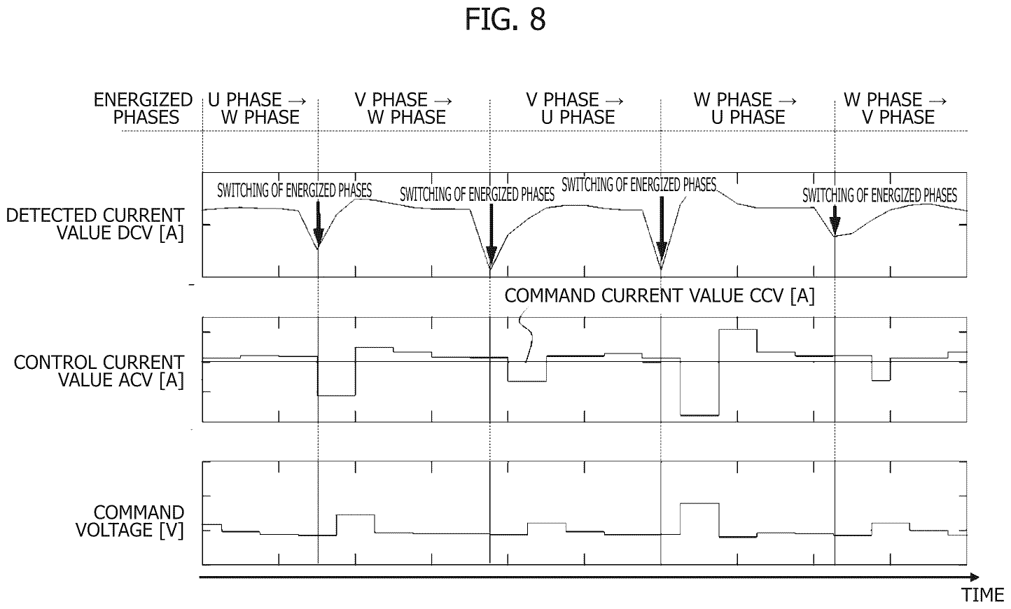

FIG. 8 is a time chart illustrating a state in which detected current value DCV detected by shunt resistor 214 temporarily drops due to switching of the energized phases, and the controlled motor current consequently oscillates.

In the 120-degree square-wave drive, the energized phases are switched each time three-phase brushless motor 12 rotates by 60 degrees. This switching of the energized phases causes a current to start to flow through the phase through which the current has not flowed until then. As a result, the phase current drops immediately after the switching of the energized phases.

Microcomputer 202a increases the command voltage by sampling the phase current that has dropped due to the switching of the energized phases, and this increase in command voltage increases the phase current. Consequently, the phase current oscillates immediately after the switching of the energized phases.

This oscillation of the phase current may cause an overcurrent or a torque control failure, which may damage the motor drive circuit or the mechanism portion of VVT mechanism 114.

Thus, when the energized phases are switched, response control unit 223 executes a process for delaying the response of control current value ACV to detected current value DCV (this process will be hereinafter referred to as “response delay process”). In this way, even when detected current value DCV temporarily drops due to the switching of the energized phases, the response delay process prevents control current value ACV used for the motor control from dropping in the same way as detected current value DCV. As a result, the oscillation of the phase current is reduced.

Since the oscillation of the phase current is reduced by the response delay process, the occurrence of an overcurrent or a torque control failure can be reduced, and damage to the motor drive circuit or the mechanism portion of VVT mechanism 114 can be avoided.

As the response delay process, response control unit 223 calculates control current value ACV based on detected current value DCV before the switching of the energized phases and based on detected current value DCV after the switching of the energized phases.

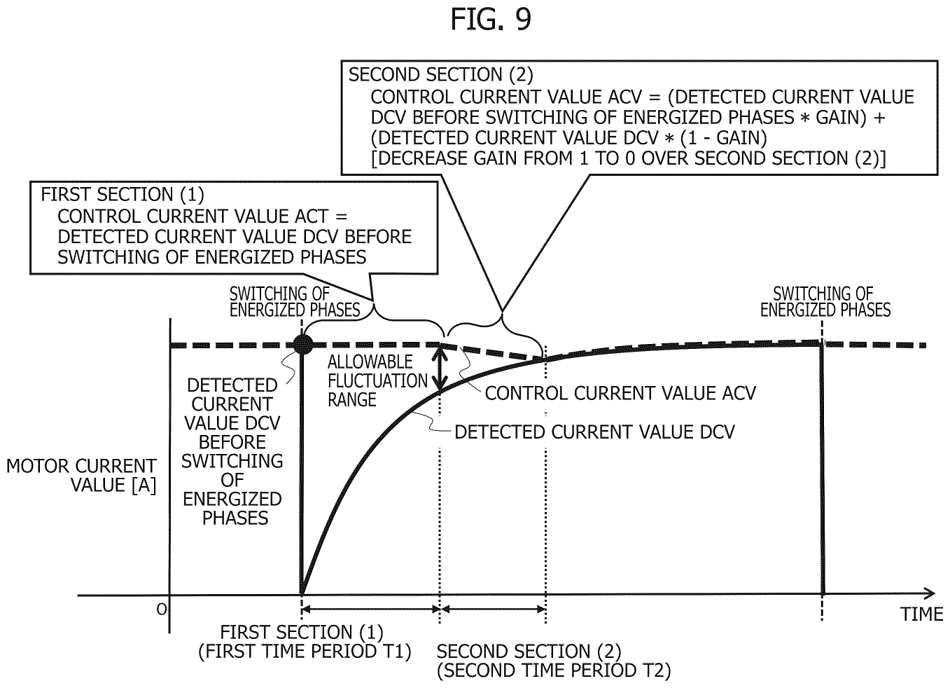

FIG. 9 is a time chart illustrating details of the response delay process.

Microcomputer 202a (response control unit 223) updates and records detected current value DCV in its internal memory each time microcomputer 202a samples detected current value DCV.

When the energized phases are switched, as a first step of the response delay process, microcomputer 202a reads out detected current value DCV sampled immediately before the switching from the memory, and holds control current value ACV at detected current value DCV immediately before the switching in a first section, that is, until a first time period T1 elapses from the switching of the energized phases.

Next, after first time period T1 elapses from the switching of the energized phases, as a second step of the response delay process, microcomputer 202a gradually brings control current value ACV closer to detected current value DCV over a second time period T2.

After microcomputer 202a matches control current value ACV with detected current value DCV, microcomputer 202a maintains this state in which control current value ACV matches detected current value DCV until the energized phases are switched next.

Microcomputer 202a calculates control current value ACV in the section (second section) corresponding to second time period T2 in accordance with the following Equation.

$$ACV = ( DCV before switching * G ) + ( DCV * ( 1 - G ) )$$

Microcomputer 202a gradually brings control current value ACV closer to the latest detected current value DCV from detected current value DCV before the switching over second time period T2, by gradually decreasing a gain G in the above Equation from 1 to 0 over second time period T2.

For example, when the target value of the phase current is the maximum current, first time period T1 is determined based on the time period (hereinafter, referred to as “recovery time period”) needed for the phase current to recover from its dropped state that has occurred due to the switching of the energized phases to an allowable current fluctuation range (for example, ±5A). Determined first time period T1 is stored in the nonvolatile memory as a constant.

That is, as one mode, first time period T1 can be determined as the time period needed for detected current value DCV after the switching of the energized phases to recover to [(detected current value DCV before switching)−5A] even when the command value of the phase current is the maximum current.

The recovery time period varies depending on the magnitude of the phase current before the switching. Thus, microcomputer 202a may variably set first time period T1 based on the current value before the switching, instead of acquiring first time period T1 as a fixed value.

That is, microcomputer 202a may calculate the time period needed for detected current value DCV to recover to the allowable current fluctuation range with respect to control current value ACV based on detected current value DCV before the switching or command current value CCV before the switching, and may variably set first time period T1 based on the calculated time period.

The response of the motor current is a first-order delay response due to the motor phase resistance and inductance, and the difference ADC between detected current value DCV before the switching and detected current value DCV after the switching is expressed by Equation 1.

$$Δ DC = ( DCV before switching ) * {e}^{\frac{t}{τ}} \qquad [ Equation 1 ]$$

In Equation 1, t represents a time constant of the motor current, and t represents a period of time elapsed from the switching of the energized phases.

Microcomputer 202a calculates time period t needed for the difference A DC to reach the allowable current fluctuation range in accordance with Equation 1, and sets the calculated time period t as first time period T1.

The configuration described above can prevent control current value ACV from being excessively held at detected current value DCV immediately before the switching, and can maintain control responsiveness with respect to command current value CCV.

In addition, if second time period T2 is short, although the current responsiveness improves, the current fluctuation increases. On the other hand, if second time period T2 is long, although the current fluctuation reduces, the current responsiveness deteriorates.

Thus, second time period T2 is set such that both the current responsiveness and the reduction of the current fluctuation can be balanced. Second time period T2 set as described above is stored in the nonvolatile memory as a constant.

Microcomputer 202a can change gain G at a constant rate over second time period T2, and can increase the decrease rate of gain G over time, for example.

Description will now be given for a case in which response control unit 223 executes the response delay process when three-phase brushless motor 12 is rotating at low speed, and a case in which response control unit 223 executes the response delay process when three-phase brushless motor 12 is rotating at high speed.

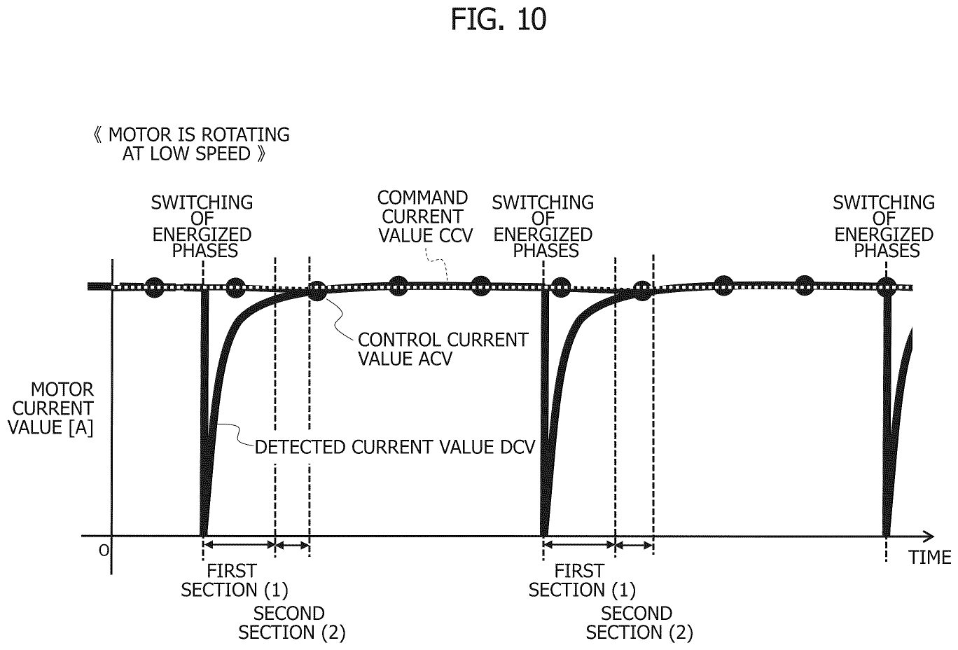

FIG. 10 illustrates a state in which response control unit 223 executes the response delay process when three-phase brushless motor 12 is rotating at low speed. During the low-speed rotation, the comparative relationship among an energized phase switching cycle, a motor control cycle, and a current drop period is represented as “energized phase switching cycle>>motor control cycle>current drop period”.

In the motor control, it is required that control current value ACV not be affected by the phase current that has dropped due to switching of the energized phases.

In the section of first time period T1 after the switching of the energized phases, control current value ACV is held at detected current value DCV before the switching of the energized phase. Thereafter, control current value ACV is brought closer to detected current value DCV in second time period T2. Thus, during the low-speed rotation, control current value ACV is prevented from being affected by the phase current that has dropped due to switching of the energized phases.

In addition, in the motor control, it is required that a motor current value be maintained at command current value CCV in the periods other than the individual phase current drop period that occurs due to the switching of the energized phases.

After the phase current drop due to the switching of the energized phases has converged, control current value ACV matches detected current value DCV, and the motor control based on detected current value DCV is substantially executed. Thus, during the low-speed rotation, the motor current value can be maintained at command current value CCV in the periods other than the individual phase current drop period.

That is, by causing response control unit 223 to execute the response delay process when three-phase brushless motor 12 is rotating at low speed, it is possible to maintain the motor current value at command current value CCV while preventing the phase current that has dropped due to the switching of the energized phases from being reflected in the control.

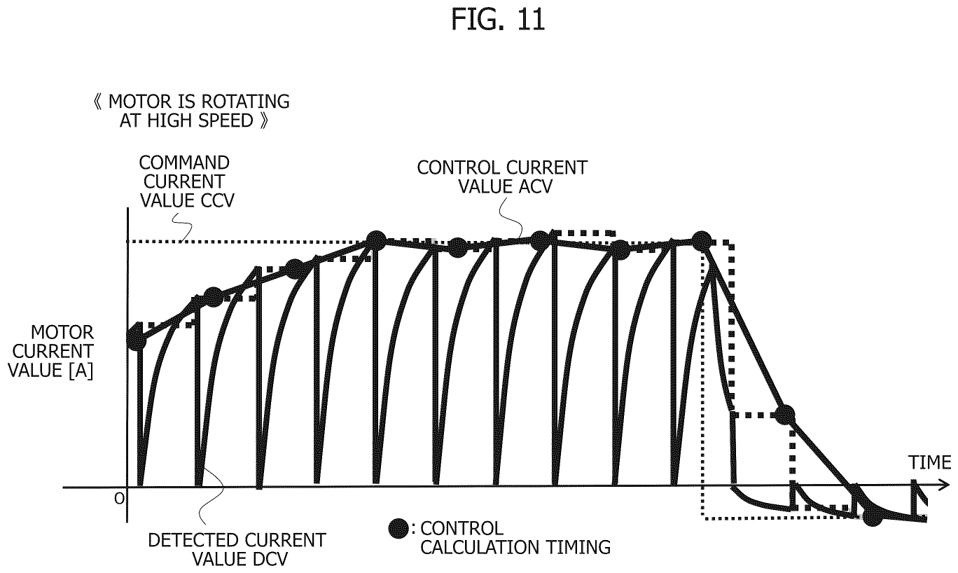

FIG. 11 illustrates a state in which response control unit 223 executes the response delay process when three-phase brushless motor 12 is rotating at high speed. During the high-speed rotation, the comparative relationship between an energized phase switching cycle and a motor control cycle is represented by “energized phase switching cycle<motor control cycle”, and the energized phase switching cycle is equal to or less than first time period T1.

The motor control during the high-speed rotation is required to realize a current limit that prevents “actual phase current>command current value CCV”.

Here, microcomputer 202a uses the phase current before the switching of the energized phases, which is the peak current, and does not use the phase current that has dropped due to the switching of the energized phases for the energization control. Thus, microcomputer 202a can realize the current limit that prevents “actual phase current>command current value CCV”.

In addition, in the motor control, it is required that the motor current value follow the change in command current value CCV.

Microcomputer 202a executes the motor control using the phase current before switching of the energized phases, which is the latest value among reliable current values. Thus, microcomputer 202a can make the motor current value follow command current value CCV.

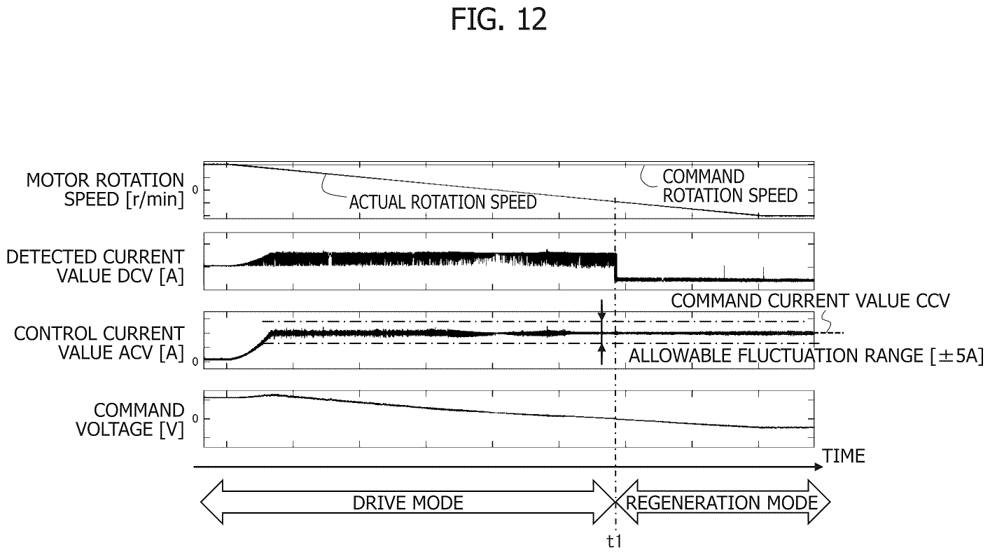

FIG. 12 is a time chart illustrating effects of the response delay process by response control unit 223.

Before time t1 in FIG. 12, the rotational direction of three-phase brushless motor 12 is the same as the direction of the voltage applied to three-phase brushless motor 12. This state is referred to as “drive mode”, in which response control unit 223 executes the response delay process and calculates control current value ACV.

In the drive mode, a current drop occurs due to the switching of the energized phases, and detected current value DCV, which is the AD-converted value of a detected signal of the current sensor, is affected by the current drop due to the switching of the energized phases and fluctuates.

In contrast, although control current value ACV used for the motor control is calculated based on detected current value DCV, control current value ACV is processed such that control current value ACV is not affected by the current drop due to the switching of the energized phases. That is, by executing the motor control based on control current value ACV, oscillation of the motor current can be maintained within the allowable range.

After time t1 in FIG. 12, the rotational direction of three-phase brushless motor 12 is opposite to the direction of the voltage applied to three-phase brushless motor 12. This state is referred to as “regeneration mode”, in which the current drop due to the switching of the energized phases does not occur.

Thus, microcomputer 202a stops the response delay process by response control unit 223 in the regeneration mode, and sets control current value ACV to detected current value DCV (that is, the current value detected by the current sensor), including the period immediately after the switching of the energized phases.

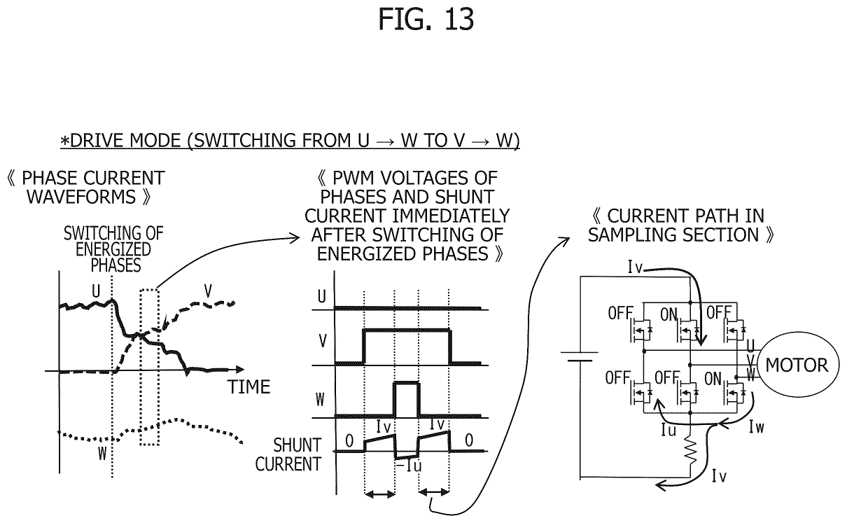

FIG. 13 illustrates the drive mode, in which the motor current is a positive current. Specifically, FIG. 13 illustrates the currents of the individual phases when switching is executed from the pattern in which a current flows from the U phase to the W phase to the pattern in which a current flows from the V phase to the W phase, the voltages of the individual phases and the current flowing through shunt resistor 214 immediately after the switching, and the current path immediately after the switching.

In the drive mode, when switching is executed from the pattern in which a current flows from the U phase to the W phase to the pattern in which the current flows from the V phase to the W phase, the U-phase terminal voltage is fixed to the ground potential (Low) by back electromotive force while a circulating current is flowing through the body diode (in other words, the parasitic diode) of U-phase lower-arm semiconductor switching element 211b.

Therefore, in the individual current sampling section, which is a period in which a potential difference is generated between the V phase and the W phase, which are the energized phases, only a current Iv of the V phase immediately after the energization starts to flow through shunt resistor 214. Thus, a current drop occurs.

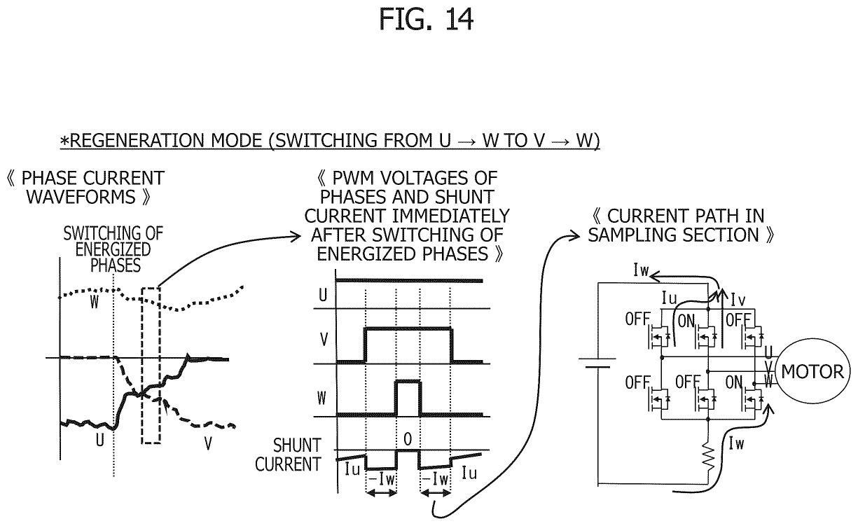

FIG. 14 illustrates the currents of the individual phases when switching is executed from the pattern in which a current flows from the U phase to the W phase to the pattern in which the current flows from the V phase to the W phase, the voltages of the individual phases and the current flowing through shunt resistor 214 immediately after the switching, and the current path immediately after the switching in the regeneration mode, in which the motor current is a negative current.

In the regeneration mode, when switching is executed from the energization pattern in which a current flows from the U phase to the W phase to the energization pattern in which a current flows from the V phase to the W phase, the U-phase terminal voltage is fixed to the power supply potential (High) by back electromotive voltage while a circulating current is flowing through the body diode (in other words, the parasitic diode) of the U-phase upper-arm semiconductor switching element 211a.

Therefore, in the individual current sampling section, which is a period in which a potential difference is generated between the V phase and the W phase, which are the energized phases, a current Iw of the W phase that has been energized before the switching of the energized phases flows through shunt resistor 214. Thus, a current drop does not occur.

As described above, since the path through which the circulating current of the open phase (the U phase in FIGS. 13 and 14) flows varies between the drive mode and the regeneration mode, the current flowing through shunt resistor 214 varies. While a current drop occurs due to the switching of the energized phases in the drive mode, a current drop does not occur due to the switching of the energized phases in the regeneration mode.

That is, microcomputer 202a causes response control unit 223 to execute the response delay process in the drive mode and causes response control unit 223 to stop the response delay process in the regeneration mode. In this way, it is possible to reduce deterioration of the current responsiveness in the regeneration mode, and to reduce the calculation load for the response delay process.

The individual technical concepts described in the above-described example can be appropriately combined and used, as long as there is no conflict.

Although the present invention has thus been described in detail with reference to a preferred example, it will be apparent to those skilled in the art that various kinds of modification modes are possible, based on the basic technical concepts and teachings of the present invention.

For example, three-phase brushless motor 12 according to the above example includes Hall sensors 12u, 12v, and 12w as the rotational position sensors that detect the motor position. However, the motor control apparatus and the motor control method according to the present invention can be applied to a sensorless three-phase brushless motor that does not include rotational position sensors such as Hall sensors.

In sensorless 120-degree energization, for example, the motor rotational position is detected by detecting a zero-cross point of the induced voltage that appears in a non-energized phase.

In the above example, microcomputer 202a holds control current value ACV at detected current value DCV before the switching of the energized phases until first time period T1 elapses from the switching of the energized phases. However, first time period T1 for which control current value ACV is held at detected current value DCV before the switching of the energized phases may be set to zero, and from the beginning of the switching of the energized phases, control current value ACV may be gradually brought closer to detected current value DCV from detected current value DCV before the switching of the energized phase over a predetermined time.

Microcomputer 202a may also obtain control current value ACV by executing a low pass filter process on detected current value DCV.

That is, another method may be adopted as long as response control unit 223 can prevent control current value ACV from changing in response to a drop of detected current value DCV when the energized phases are switched.

The three-phase brushless motor is not limited to a motor for VVT mechanism 114, and it is not also limited to a motor that operates in the drive mode and the regeneration mode.

### REFERENCE SYMBOL LIST

12 Three-phase brushless motor
114 VVT mechanism
202 VVT controller (motor control apparatus)
202a Microcomputer (control unit)
211 Inverter
213 Inverter drive circuit
214 Shunt resistor (current sensor)
222 Phase current detection unit
223 Response control unit
224 Current control unit
225 Command voltage/duty ratio conversion unit
226 Energized phase determination unit
227 PWM signal generation unit

1. A motor control apparatus comprising a control unit configured to acquire a detected signal of a current sensor that detects a current flowing through energized phases of a three-phase brushless motor, and to execute 120-degree square-wave drive on the three-phase brushless motor, based on a control current value based on the detected signal,
wherein the control unit calculates the control current value based on a current value detected by the current sensor before switching of the energized phases in the 120-degree square-wave drive and a current value detected by the current sensor after the switching.

2. The motor control apparatus according to claim 1, wherein the control unit holds the control current value at the current value detected by the current sensor before the switching of the energized phases until a first time period elapses from the switching of the energized phases, and after the first time period elapses, gradually brings the control current value closer to the current value detected by the current sensor over a second time period.

3. The motor control apparatus according to claim 2, wherein the control unit changes the first time period, based on a motor current value or a command current value.

4. The motor control apparatus according to claim 1, wherein when a rotational direction of the three-phase brushless motor and a direction of a volage applied to the three-phase brushless motor are opposite to each other, the control unit sets the control current value to the current value detected by the current sensor.

5. The motor control apparatus according to claim 1, wherein the current sensor is configured to include a shunt resistor disposed on a direct-current bus line of an inverter that supplies alternate-current power to the three-phase brushless motor.

6. The motor control apparatus according to claim 5,
wherein the control unit is configured to execute 120-degree square-wave drive on the three-phase brushless motor by controlling the inverter that supplies alternate-current power to the three-phase brushless motor based on pulse width modulation (PWM), and
wherein the control unit sets a time period during which a current flows through the shunt resistor to be equal to or greater than a minimum time period for current detection, by executing pulse shift control for shifting a phase of a PWM pulse.

7. A motor control apparatus comprising a control unit configured to acquire a detected signal of a current sensor that detects a current flowing through energized phases of a three-phase brushless motor, and to execute 120-degree square-wave drive on the three-phase brushless motor, based on a control current value based on the detected signal,
wherein the control unit delays a response of the control current value to the current value detected by the current sensor when switching of the energized phases is executed in the 120-degree square-wave drive.

8. A motor control method in which a control unit executes 120-degree square-wave drive on a three-phase brushless motor, the motor control method comprising:
acquiring a detected signal of a current sensor that detects a current flowing through energized phases of the three-phase brushless motor,
calculating a control current value based on the detected signal; and
outputting a control signal to a drive circuit of the three-phase brushless motor based on the control current value,
wherein in the calculating of the control current value, the control current value is calculated based on a current value detected by the current sensor before switching of the energized phase in the 120-degree square-wave drive and a current value detected by the current sensor after the switching.

9. The motor control method according to claim 8, wherein the calculating of the control current value includes: holding the control current value at the current value detected by the current sensor before the switching of the energized phases until a first time period elapses from the switching of the energized phases; and gradually bringing, after the first time period elapses, the control current value closer to the current value detected by the current sensor over a second time period.
